(19) United States
(12) Patent Application Publication
(10) Pub. No.: US 2018/0075074 A1
(43) Pub. Date: Mar. 15, 2018

(54) APPARATUS AND METHOD TO CORRECT INDEX TREE DATA ADDED TO EXISTING INDEX TREE DATA

(71) Applicant: FUJITSU LIMITED, Kawasaki-shi (JP)

(72) Inventor: Toshihiro SHIMIZU, Sagamihara (JP)

(73) Assignee: FUJITSU LIMITED, Kawasaki-shi (JP)

(21) Appl. No.: 15/682,865

(22) Filed: Aug. 22, 2017

(30) Foreign Application Priority Data
Sep. 12, 2016 (JP) 2016-177529

(51) Int. Cl. G06F 17/30

(52) U.S. Cl. CPC G06F 17/30336; G06F 17/30327

(57) ABSTRACT

An apparatus executes preprocessing for an information processing apparatus that maintains a database according to index data having a tree structure, where the tree structure includes plural pieces of node data and plural pieces of edge data linking the plural pieces of node data. The apparatus stores existing index data of the database, and receives input data to be added to the database. The apparatus compares the existing index data with input index data included in the input data, and extracts, from the input index data, new node data indicating a difference between the existing index data and the input index data. The apparatus creates additional index data including new tree data in which pieces of the new node data are continuously arranged, and transmits the additional index data to the information processing apparatus.

### CROSS-REFERENCE TO RELATED APPLICATION

This application is based upon and claims the benefit of priority of the prior Japanese Patent Application No. 2016-177529, filed on Sep. 12, 2016, the entire contents of which are incorporated herein by reference.

### FIELD

The embodiment discussed herein is related to apparatus and method to correct index tree data added to existing index tree data.

### BACKGROUND

Conventionally, an information processing device that manages a database has managed data by using an index. The index employs a data structure such as a tree structure, for example, B-tree, and a bit map structure to manage a data group accumulated in the database. The use of the index allows the information processing device to store input data in the database in a manner organized and easy to process, thereby increasing the execution speed of processing on the database, such as search request and data extraction processing.

With recent development of the information and communication technology (ICT), a technology called Internet of Things (IoT) has been developed in which various “objects” having a communication function are coupled with a communication network such as the Internet. In the IoT, for example, observation data observed by various communication devices coupled with a communication network is continuously added to and accumulated in a database. The data accumulated in the database is used by, for example, a smartphone or any other communication device coupled through the communication network to preform data search and extraction or to analyze the data for a predetermined purpose. An information processing device managing the database tends to have a processing load increased due to the co-occurrence of addition and accumulation processing of input data to the database and search and update processing on the accumulated data.

Japanese Laid-open Patent Publication No. 11-31147 discloses a technique related to a technique described in the present specification.

### SUMMARY

According to an aspect of the invention, an apparatus executes preprocessing for an information processing apparatus that maintains a database according to index data having a tree structure, where the tree structure includes plural pieces of node data and plural pieces of edge data linking the plural pieces of node data. The apparatus stores existing index data of the database, and receives input data to be added to the database. The apparatus compares the existing index data with input index data included in the input data, and extracts, from the input index data, new node data indicating a difference between the existing index data and the input index data. The apparatus creates additional index data including new tree data in which pieces of the new node data are continuously arranged, and transmits the additional index data to the information processing apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an information processing device configured to manage a database, according to an embodiment;

FIG. 2 is a diagram illustrating an example of a distribution system for reducing a processing load on a database server, according to an embodiment;

FIG. 3 is a diagram illustrating an example of merge processing using a Trie-tree for an index, according to an embodiment;

FIG. 4 is a diagram illustrating an example of an index file at merge processing by breadth-first search, according to an embodiment;

FIG. 5 is a diagram illustrating an example of an index file at merge processing by depth-first search, according to an embodiment;

FIG. 6 is a diagram illustrating an example of a distribution system, according to an embodiment;

FIG. 7 is a diagram illustrating an example of a hardware configuration of a preprocessing server, according to an embodiment;

FIG. 8 is a diagram illustrating an example of a hardware configuration of a DB server, according to an embodiment;

FIG. 9 is a diagram illustrating an example of implementation of an index having a trie structure, according to an embodiment;

FIG. 10 is a diagram illustrating an example of implementation of a trie structure in array and list forms, according to an embodiment;

FIG. 11 is a diagram illustrating an example of an existing index, according to an embodiment;

FIG. 12 is a diagram illustrating an example of an index for input data, according to an embodiment;

FIG. 13 is a diagram illustrating an example of an updated index, according to an embodiment;

FIG. 14 is a diagram illustrating an example of a file of an additional index, according to an embodiment;

FIG. 15 is a diagram illustrating an example of additional data creation processing, according to an embodiment;

FIG. 16 is a diagram illustrating an example of an operational flowchart for additional data creation processing performed by a preprocessing server, according to an embodiment;

FIG. 17 is a diagram illustrating an example of transition of nodes at additional data creation processing, according to an embodiment;

FIG. 18 is a diagram illustrating an example of transition of nodes when additional data creation processing is continued for another string, according to an embodiment;

FIG. 19 is a diagram illustrating an example of an operational flowchart for additional data merge processing performed by a DB server, according to an embodiment; and

FIG. 20 is a diagram illustrating an example of addition of any edge between an existing node and a new node, according to an embodiment.

### DESCRIPTION OF EMBODIMENT

An index using a tree structure has a data structure in which nodes as data elements of the index are tiered by being linked in a parent-child relation and a sibling relation. The link (hereinafter also referred to as an edge) between nodes in the above relation is expressed by, for example, a pointer indicating a relative position in the index.

Added tree data including an index in the tree structure is input to an information processing device including a database. Merge processing is performed to merge the added tree data and an index (hereinafter also referred to as existing tree data) of existing data accumulated in the database.

The added tree data includes a duplicate node, which is also included in the existing tree data, and a node new to the existing tree data. The information processing device scans the added tree data and existing tree data to find new nodes and duplicate nodes, and performs the merge processing of merging the new nodes into the existing tree data. The scanning processing involves searching all nodes along the tree structure of each tree data, and accordingly imposes a processing load on the information processing device.

In the merge processing, since the new node is merged into the existing tree data, relative positions between nodes after the merging are changed. To rewrite pointers between nodes to pointers suited to a tree structure after data update, the information processing device performs the scanning processing again on the existing tree data merged with the new nodes.

In the information processing device, in which observation data is continuously added to and accumulated in the database, a processing load due to the merge processing is generated every time input data is added. For this reason, the information processing device has a risk of delay in update processing of the database. More specifically, the information processing device managing the database has risks of reduction in the processing speed for data updating and degradation in the efficiency of search and extraction processing on an accumulated data group.

According to an aspect, an embodiment is intended to reduce a load on an information processing device configured to manage index data, when performing merge processing of added tree data and existing tree data.

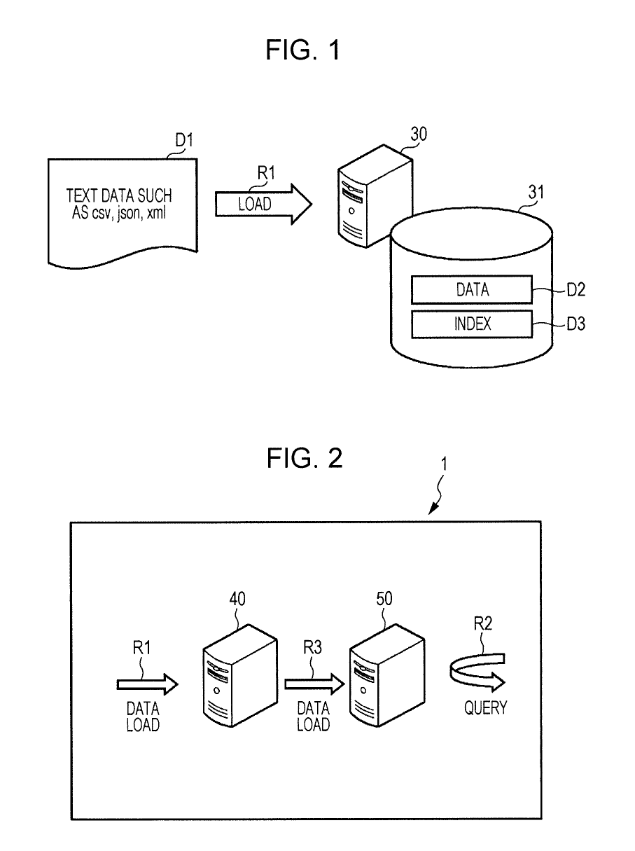

An information processing device according to an embodiment will be described below with reference to the accompanying drawings. A configuration according to the embodiment described below is exemplary, and the information processing device is not limited to the configuration of the embodiment. The following describes the information processing device according to the embodiment with reference to FIGS. 1 to 20.

### Embodiment

(Discussion of Reduction of Load on Database Server)

FIG. 1 illustrates an explanatory diagram of an information processing device configured to manage database. This information processing device 30 includes a database for storing and accumulating data input through a communication network (not illustrated). The database is stored in a recording device 31. The information processing device 30 is, for example, a desktop personal computer or a server. The recording device 31 is, for example, a solid state drive device, a hard disk drive, or a DVD drive device. The communication network (not illustrated) includes, for example, a public network such as the Internet, a wired network such as a local area network (LAN), and a wireless network such as a cellular phone network or a wireless LAN. The information processing device 30 stores a database in a storage region of a recording medium (for example, a silicon disk, a hard disk, or a DVD) supported by the recording device 31. In the following, the information processing device 30 configured to manage a database is also referred to as the database server 30.

Various communication devices each having a communication function are coupled through the communication network (not illustrated). For example, data D1 observed by a communication device is input to the database server 30. The data D1 is exemplified by text data written in comma-separated values (CSV), JavaScript (registered trademark) Object Notation (JSON), or Extensible Markup Language (XML).

The database server 30 receives the input data D1 and performs data generation processing for storing the received data D1 in the database. In the data generation processing, elements of the received data D1 are restructured in accordance with a table form of the database. In the data generation processing, partial information of the data D1 is used to create an index for performing data management. In the embodiment, the data D1 includes at least one element. An element is a part of data as a node stored in the database.

Examples of a data structure of an index generated through the data generation processing include a tree structure such as a B-tree. In the tree structure, data elements (nodes) of the index are coupled with each other in a vertical relation such as a parent-child relation and in a horizontal relation such as a sibling relation, thereby achieving a tiered data structure. Connection (edge) between nodes in the above-described relation is expressed in a pointer indicating relative positions in the index.

The database server 30 stores, in the database, an index generated together with records restructured through the data generation processing. The database stores and accumulates, as data D2, the record restructured from the data D1. The database stores an index D3 updated through merge processing by the database server 30.

In the merge processing, the index generated from the data D1 is merged with an existing index of a data group accumulated in the database. In the database server 30, the merge processing is performed at each reception of input data, and the updated index D3 is stored. The index of the data D1 includes a node (duplicate node) that is also included in the existing index, and a node (new node) that is new to the existing index.

FIG. 2 exemplarily illustrates a distribution system for reducing a processing load on the database server. In FIG. 2, the distribution system 1 includes a data generation server 40 and a database server 50 coupled with each other. The data generation server 40 receives, for example, the data D1 continuously input from various communication devices (data load R1) and performs the data generation processing. The database server 50 performs, for example, processing of handling queries from a plurality of information processing devices (not illustrated), which uses data accumulated in a database (query R2).

In the distribution system 1, a function to execute the data generation processing at data input, which is performed by the database server 30 in FIG. 1, is distributed to the data generation server 40. This reduces a processing load on the database server 50. In the distribution system 1 in which the processing load on the database server 50 is reduced, it is possible to perform processing, such as on-line analytical processing (OLAP), of swiftly presenting a result by performing complicate counting and analysis of a large amount of data accumulated in a database. In the distribution system 1, it is possible to perform data processing such as on-line transaction processing (OLTP) in response to processing requests for data accumulated in a database from a plurality of information processing devices. In the distribution system 1, since the processing load on the database server 50 is reduced, the OLAP and the OLTP are both expected to be performed.

In the distribution system 1 in FIG. 2, a result of the data generation processing is output from the data generation server 40 to the database server 50 (data load R3). The database server 50 performs processing of merging an index generated by the data generation server 40 with an existing index of a data group accumulated in the database. In the database server 50, each time the data load R3 is performed, the merge processing is performed to restructure a tree-structure index of the database with updated data.

In the distribution system 1 in FIG. 2, the database server 50 performs the merge processing described with reference to FIG. 1.

In the embodiment, for example, a Trie-tree (hereinafter also referred to as a trie) is used as the tree structure of an index. When the trie is used as the data structure of an index, an additional processing time tends to be affected by the data size of an index to be added, not by the data size of an existing index.

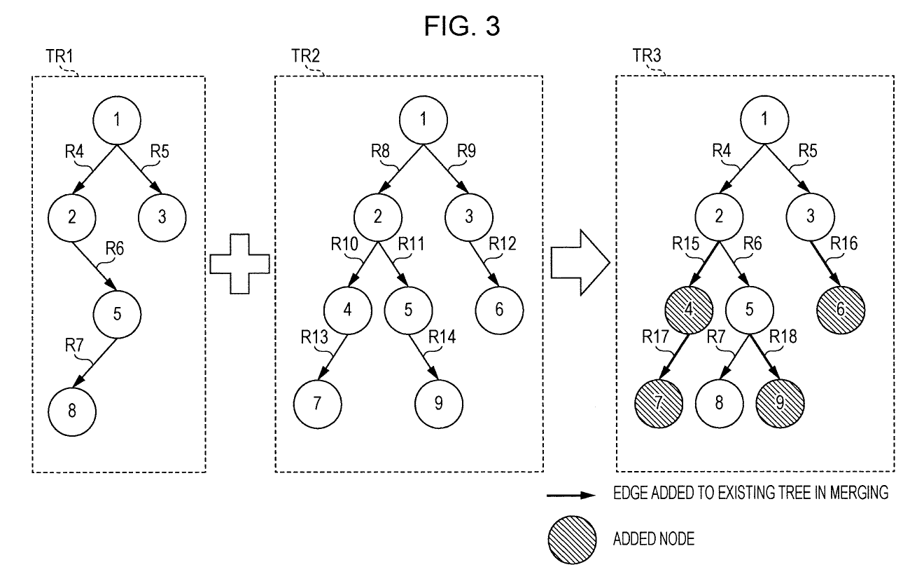

FIG. 3 exemplarily illustrates an explanatory diagram of the merge processing when a trie structure is used for an index. In FIG. 3, TR1, TR2, and TR3 each enclosed in a rectangular frame illustrated with a dashed line indicate indices having the trie structure. The use of the trie structure allows an index group including at least one index to be expressed in one tree structure by linking nodes as data elements of each index with each other through an edge relation. A node of one index may be a duplication of a node of another index. The edge relation of nodes duplicated between indices is determined according to a predetermined rule for the trie structure. Hereinafter, one index in an index group expressed in the trie structure is also referred to as an index element.

In FIG. 3, TR1 represents an existing index, TR2 represents an index to be added, and TR3 represents a merged index obtained through the merge processing. In TR1, TR2, and TR3, a circled number indicates a node of an index element grouped in an index. Each of R4 to R18 indicates an edge representing a link (association) between nodes. In TR3, circled numbers “4”, “6”, “7”, and “9” hatched with slanting lines indicate nodes added through the merge processing.

In a tree structure, a vertical relation between nodes is what is called a parent-child relation, and a horizontal relation between nodes side by side at an identical level is what is called a sibling relation. Nodes in the sibling relation have edges to an identical parent node. A node having no edge to a parent node is also referred to as a root node. For example, in TR1 in FIG. 3, node “1” is a root node and the parent node of node “2”. Node “1” is the parent node of node “3”. Node “2” and node “3” are in the sibling relation with the parent node “1”. Nodes in the sibling relation are arranged side by side at an identical level in the tree structure.

The merge processing specifies a new node in TR2 not included in TR1, while performing scanning processing on TR1 as an existing index and TR2 as an index to be added. In the scanning processing, for example, processing is performed on all nodes along the tree structure. The processing on all nodes in the tree structure is performed based on each edge linking nodes.

Examples of the scanning processing of the tree structure include depth-first search and breadth-first search. Processing of the depth-first search searches for, for example, existence of any edge of a target node, and if any edge exists, specifies a child node at the terminal of the edge. Then, the processing of the depth-first search scans the tree structure by repeating the above-described processing on the specified child node as a search target. Processing of the breadth-first search scans the tree structure sequentially from a higher level to a lower level, by targeting nodes at an identical level.

In an exemplary search on TR1, the scanning processing by the depth-first search specifies root node “1”, and specifies edges (R4 and R5) of root node “1”. For example, the scanning processing by the depth-first search specifies node “2” along the specified left edge R4 and repeats the above-described processing on the specified node “2”. After the processing on the left edge R4, the scanning processing by the depth-first search repeats the above-described processing on the right edge R5. In TR1, the scanning processing by the depth-first search scans nodes in the order of node “1”->edge R4->node “2”->edge R6->node “5”->edge R7->node “8”->edge R5->node “3”.

The scanning processing by the breadth-first search specifies node “1” in TR1, and specifies nodes “2” and “3” at an identical level along edges (R4 and R5) of root node “1”. Then, the scanning processing by the breadth-first search repeats the above-described processing on node “2” having an edge to a lower level. The scanning processing by the breadth-first search in TR1 scans nodes in the order of node “1”->edge R4->node “2”->edge R5->node “3”->edge R6->node “5”->edge R7->node “8”.

For example, the merge processing alternately performs the above-described scanning processing on each node in TR1 and TR2 to specify a new node in TR2, which is not found in TR1. In the example in FIG. 3, when referring to node “4” along edge R10 from node “2” in TR2, the merge processing specifies, as new nodes, node “4” linked with edge R10 and node “7” linked with edge R13. This is because node “4” is not found in TR1. Nodes linked through an edge are also referred to as a subtree.

Similarly, in TR2, the merge processing specifies, as new nodes, node “9” linked to node “5” through edge R14, and node “6” linked to node “3” through edge R12. When having referred to each of new nodes “4”, “7”, “9”, and “6”, the merge processing adds the node as a data element in TR1.

After addition of any new node found in TR2, the merge processing performs scanning processing again on TR3 to which the new node has been added. This is to restructure each edge linking nodes in TR3 to which the node new has been added. In the example in FIG. 3, the merge processing refers to node “2” along edge R4 from root node “1”. Then, the merge processing adds, to TR1, an edge relation (edge R15) linking node “2” and node “4”.

Similarly, the merge processing refers to node “5” along edge R6 from node “2”. Then, the merge processing adds, to TR1, an edge relation (edge R18) linking node “5” and node “9”. In addition, the merge processing refers to root node “3” along edge R5 from node “1”. Then, the merge processing adds, to TR1, an edge relation (edge R16) linking node “3” and node “6”. The merge processing also performs rewriting that sets an edge between nodes “4” and “7” in a new subtree not found in TR1 as edge R17. In TR3 in FIG. 3, a bold arrow represents an edge added to TR1 through the merge processing between TR1 and TR2.

An index having the trie structure described with reference to FIG. 3 is a file that stores data elements (nodes) of index elements grouped in the index. An edge linking nodes may be expressed as an offset between the storage positions of the nodes in the file. For example, an edge between nodes linked in the parent-child relation is expressed as a relative offset of the storage position of the child node relative to the storage position of the parent node. The following describes the merge processing in the file.

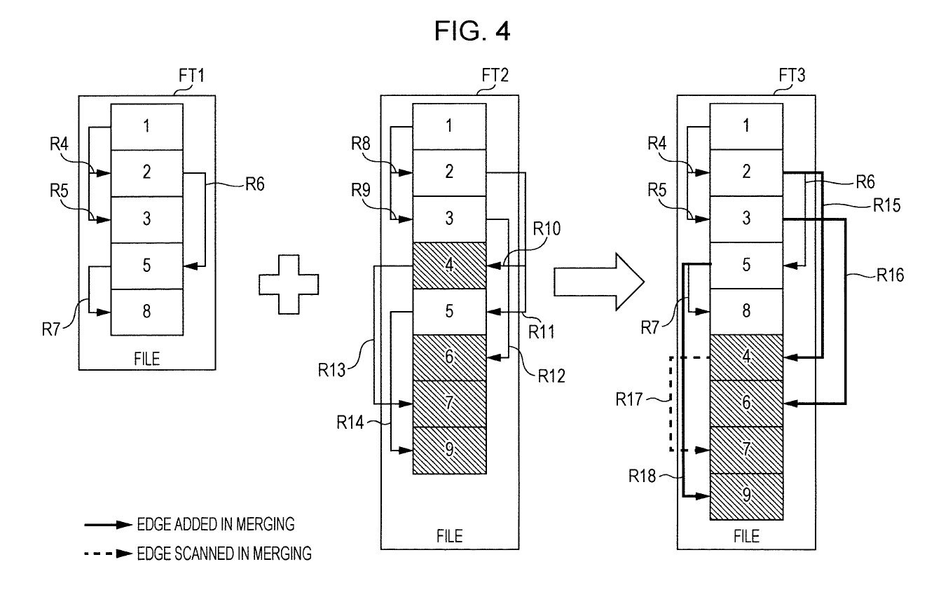

FIG. 4 exemplarily illustrates an explanatory diagram of index files at the merge processing by the breadth-first search. In FIG. 4, FT1, FT2, and FT3 enclosed in rectangular frames illustrated with solid lines represent files for TR1, TR2, and TR3, respectively, which are exemplarily illustrated as indices having the trie structure in FIG. 3. In each of FT1, FT2, and FT3, a numbered rectangular frame represents a node as a data element of the index. In FT2 and FT3, rectangular frames hatched with slanting lines and having numbers “4”, “6”, “7”, and “9” each represent a new node not found in FT1 as an existing index. The arrangement order of nodes in each file is determined in accordance with a search method of the scanning processing.

In FIG. 4, similarly to FIG. 3, R4 to R18 each represent an edge linking nodes. In a file, edges R4 to R18 linking nodes are each expressed as an offset between the linked nodes. Each offset between nodes is determined in accordance with the search method of the scanning processing.

Nodes in FT1 to FT3 in FIG. 4 are continuously stored. In FT1, for example, edge R4 between node “1” and node “2” is expressed as a relative offset value (pointer) pointing from the current storage position of node “1” to the current storage position of node “2”. For example, edge R4 between node “1” and node “2” is expressed as an offset value of +1. Similarly, edge R5 is expressed as an offset value of +2, edge R6 is expressed as an offset value of +2, and edge R7 is expressed as offset value of +i.

As described with reference to FIG. 3, in the breadth-first search, nodes are scanned in the arrangement order of node “1”->node “2”->node “3”->node “5”->node “8” as illustrated in FT1. In addition, nodes are scanned in the arrangement order of node “1”->node “2”->node “3”->node “4”->node “5”->node “6”->node “7”->node “9” as illustrated in FT2.

In the merge processing, when a node (new node) not found in an existing index (FT1) is found in an index to be added (FT2), the node (new node) is added to the existing index. A new node in a file is added at a position following the storage position of node “8” in FT1. In the scanning processing by the breadth-first search, nodes are scanned in the order of levels, and thus nodes 5 and 6 on a level identical to that of node 4 are scanned after node “4” is added the existing index. As illustrated in FT3, new nodes in FT2 are added in an order in which they are found through the breadth-first search.

As described with reference to FIG. 3, after the addition of any new node, scanning processing is performed to add an edge to the new node. As illustrated with a bold arrow in FT3 in FIG. 4, the offset value of edge R15 linking node “2” and new node “4” is added through the scanning processing. Similarly, the offset value of edge R16 linking node “3” and new node “6”, and the offset value of edge R18 linking node “5” and new node “9” are added.

In the scanning processing by the breadth-first search, the offset value of edge R13 between node “4” and node “7” as a subtree is rewritten to the offset value of edge R17 illustrated with a solid dashed arrow. As illustrated in TF2, the offset value of edge R13 is +3. Edge R13 linking node “4” and node “7” is rewritten to edge R17 having an offset value of +2 through scanning processing after subtree merge.

Comparison between arrangements of new nodes in FT2 and FT3 in FIG. 4 finds that new nodes “4”, “6”, “7”, and “9” merged with the existing index are distributed in FT2. For example, if a new node in FT2 is continuous in a block of a group of nodes as illustrated in FT3 after merge, the block may be collectively added to the existing index when the new node is found.

Thus, in the merge processing exemplarily illustrated in FIG. 4, the scanning processing on an existing index and an added index may be terminated when a new node is found in the added index. Accordingly, a load reduction in the merge processing is expected. The following discusses the scanning processing by the depth-first search.

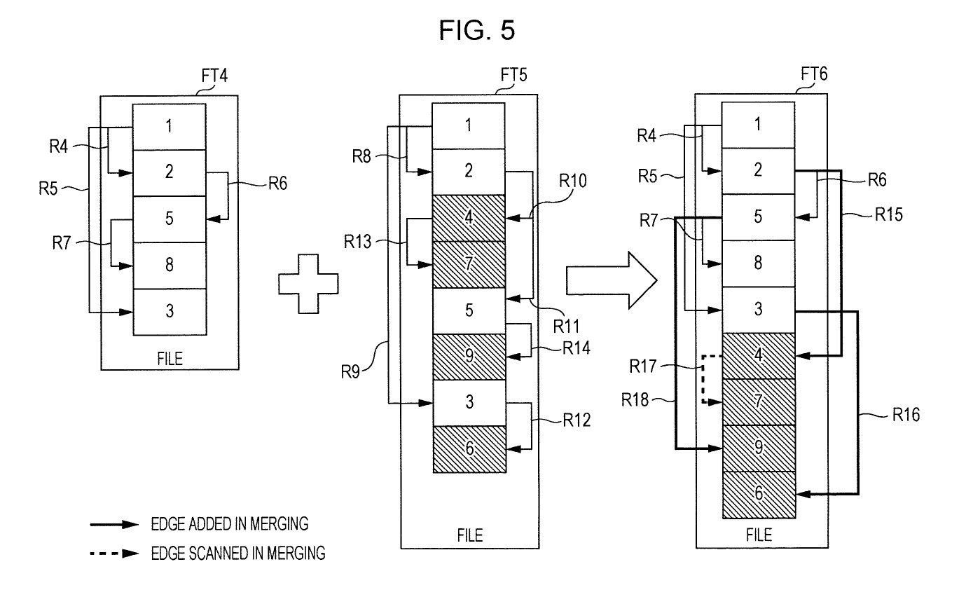

FIG. 5 exemplarily illustrates an explanatory diagram of index files at the merge processing in the depth-first search. In FIG. 5, FT4, FT5, and FT6 enclosed in rectangular frames illustrated with solid lines are files for TR1, TR2, and TR3, respectively, which have been exemplarily illustrated as indices having the trie structure in FIG. 3. In each of FT4, FT5, and FT6, a numbered rectangular frame represents a node as a data element of the index, and rectangular frames hatched with slanting lines and having numbers “4”, “6”, “7”, and “9” each represent a new node not found in FT4 as an existing index. R4 to R18 each represent an edge linking nodes.

The arrangement orders of nodes in FT4, FT5, and FT6 are determined in accordance with the search method of the scanning processing. In the depth-first search, nodes in an existing index are scanned in the arrangement order of node “1”->node “2”->node “5”->node “8”->node “3” as illustrated in FT4. Nodes in an added index are scanned in the arrangement order of node “1”->node “2”->node “4”->node “7”->node “5”->node “9”->node “3”->node “6” as illustrated in FT5.

In the depth-first search, new nodes are distributed as illustrated in FT5. In the merge processing by the depth-first search, nodes “4” and “7” as a subtree are added at positions following node “3” as illustrated in FT6. Other new nodes “9” and “6” in FT5 are added at positions following node “7” when being found. In the depth-first search, the new nodes “4”, “7”, “9”, and “6” in FT5 are merged with FT4 in this order.

In the depth-first search, after the addition of any new node, scanning processing is performed to add an edge to the new node. In FIG. 5, as illustrated with a bold arrow in FT6, the scanning processing adds the offset value of edge R15 linking node “2” and new node “4” of +4. The scanning processing also adds the offset value of edge R18 linking node “5” and new node “9” of +5, and the offset value of edge R16 linking node “3” and new node “6” of +4.

As described with reference to FIG. 3, in the scanning processing by the depth-first search, new nodes “4” and “7” to be a subtree are added to FT4 while being kept in an offset relation represented by edge R13 in FT5. Accordingly, an offset value between new nodes merged with FT4 as continuous nodes is maintained after the merge (solid dashed arrow R17). Thus, no rewriting of an offset value between new nodes added as a subtree occurs.

In the scanning processing by the depth-first search, new nodes “4”, “7”, “9”, and “6” merged with an existing index are distributed as discussed in FIG. 4. Thus, in the depth-first search, if a new node to be merged with the existing index is continuous in a block of a group of continuous nodes, the block may be collectively added to the existing index when the new node is found.

Accordingly, in the merge processing by the depth-first search exemplarily illustrated in FIG. 5, the scanning processing on an existing index and an added index may be terminated when a new node is found in the added index. Another load reduction in the merge processing is expected in the depth-first search.

In addition, as described with reference to an offset between nodes as a subtree in FIG. 5, an offset value between nodes in a block of a group of continuous nodes is maintained after merge. Thus, if new nodes to be merged with an existing index are continuous in a block of a group of continuous nodes, an offset relation between the new nodes in the block is maintained. After the block is merged with the existing index, no rewriting of the offset value between the new nodes occurs.

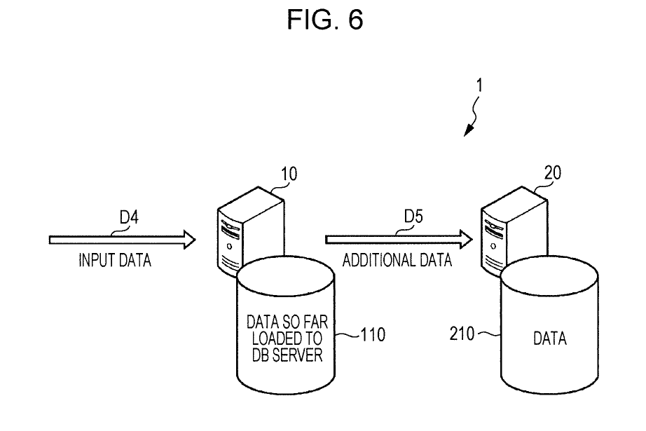

FIG. 6 illustrates an exemplary distribution system 1 according to the embodiment. The distribution system 1 according to the embodiment includes a preprocessing server 10 and a database server 20 coupled with each other. In the distribution system 1 in FIG. 6, the database server 20 includes a database 210 in a recording device provided to the database server 20. The database 210 stores the index D3 described with reference to FIG. 1. In the distribution system 1 in FIG. 6, as described with reference to FIG. 2, the preprocessing server 10 receives, for example, input data D4 continuously input from various communication devices each having a communication function. The database server 20 performs processing of handling queries from, for example, a plurality of information processing devices using a data group accumulated in the database 210.

In the distribution system 1 according to the embodiment, a tree structure using a trie is employed as the data structure of an index. The use of the trie structure allows index update processing in the distribution system 1, independently of the amount of existing data accumulated in the database server 20. In the distribution system 1, the data size (file size) of an index is determined depending on data to be added. Thus, in the embodiment, the data size of an index does not depend on the data size of an original tree as illustrated in FIG. 4. Increase in a processing time of update processing may be reduced when the data size of an index is determined depending on data to be added.

In the distribution system 1 according to the embodiment, as discussed with reference to FIGS. 3, 4, and 5, an index to be added is created so that a new node merged with an existing index is continuous in a block of a group of continuous nodes.

Specifically, the preprocessing server 10 stores, as a database 110 in an auxiliary storage unit provided to the preprocessing server 10, a data group accumulated in the database 210 of the database server 20. Upon receiving the input data D4, the preprocessing server 10 creates the additional index to be added by using the data group accumulated in the database 110. The additional index created by the preprocessing server 10 collectively stores a new node as part of a block of a group of continuous nodes in an existing index in the input data D4. The preprocessing server 10 transmits the created additional index to the database server 20 as additional data D5.

The database server 20 merges the block of the additional data D5 with an existing index managed by the database server 20, and adds an edge between a merged new node and an existing node. Edge rewriting is performed based on an edge relation between an existing node and a new node in the additional data D5.

The database server 20 specifies, for example, the block of a new node in the additional data D5 as a difference from the existing index and merges the new node and adds an edge between the merged new node and an existing node, which completes index update processing. This leads to a load reduction in the merge processing at the database server 20.

The preprocessing server 10 preferably stores, as the database 110 in a recording device provided to the preprocessing server 10, a data group accumulated in the database 210 of the database server 20. This is because a plurality of indices may be created in accordance with the type of data accumulated in the database. However, when the type of index-creation target data is set in advance, the storage in the database 110 may be performed only for, for example, an existing index.

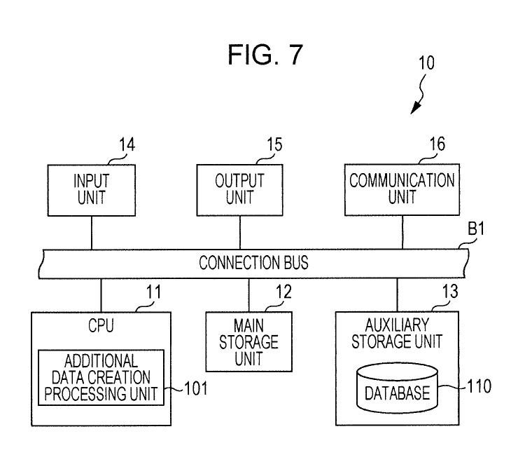

FIG. 7 illustrates an exemplary hardware configuration of the preprocessing server 10. The preprocessing server 10 includes a central processing unit (CPU) 11, a main storage unit 12, an auxiliary storage unit 13, an input unit 14, an output unit 15, and a communication unit 16, which are coupled with each other through a connection bus B1. The main storage unit 12 and the auxiliary storage unit 13 are recording media readable by the preprocessing server 10. The auxiliary storage unit 13 is a recording device storing the database 110.

In the preprocessing server 10, the CPU 11 loads, in an executable form on a work area of the main storage unit 12, a computer program stored in the auxiliary storage unit 13, and controls any peripheral instrument through execution of the computer program. In this manner, the preprocessing server 10 may execute processing in accordance with a certain purpose.

The CPU 11 is a central processing device configured to control the entire preprocessing server 10. The CPU 11 performs processing in accordance with the computer program stored in the auxiliary storage unit 13. The main storage unit 12 is a storage medium in which the CPU 11 caches the computer program and data, and provides a work area. The main storage unit 12 includes, for example, a flash memory, a random access memory (RAM), or a read only memory (ROM).

The auxiliary storage unit 13 stores various computer programs and various kinds of data in a readable and writable manner in a recording medium. The auxiliary storage unit 13 is also called an external storage device. The auxiliary storage unit 13 stores, for example, an operating system (OS), various computer programs, and various tables. The OS includes a communication interface program configured to perform data transfer with an external device or the like coupled through the communication unit 16. Examples of the external device or the like include information processing devices, such as a PC and a server on the communication network (not illustrated), a smartphone, and external storage devices.

The auxiliary storage unit 13 is, for example, an erasable programmable rom (EPROM), a solid state drive device, or a hard disk drive (HDD) device. Examples of the auxiliary storage unit 13 include a CD drive device, a DVD drive device, and a BD drive device. Examples of the recording medium include a silicon disk including a non-transitory semiconductor memory (flash memory), a hard disk, a CD, a DVD, a BD, a universal serial bus (USB) memory, and a secure digital (SD) memory card.

The input unit 14 receives an operation instruction or the like from, for example, an administrator of the preprocessing server 10. The input unit 14 is an input device such as an input button, a pointing device, or a microphone. The input unit 14 may be an input device such as a keyboard or a wireless remote controller. Examples of the pointing device include a touch panel, a mouse, a track ball, and a joystick.

The output unit 15 outputs data and information processed by the CPU 11, and data information stored in the main storage unit 12 and the auxiliary storage unit 13. Examples of the output unit 15 include display devices such as a liquid crystal display (LCD), a plasma display panel (PDP), an electroluminescence (EL) panel, and an organic EL panel. The output unit 15 may be an output device such as a printer or a speaker. The communication unit 16 is an interface for, for example, a communication network coupled with the distribution system 1.

In the preprocessing server 10, the CPU 11 provides an additional data creation processing unit 101 together with execution of a target computer program, by reading, onto the main storage unit 12, and executing the OS, various computer programs, and various kinds of data stored in the auxiliary storage unit 13. The preprocessing server 10 includes, in the auxiliary storage unit 13, for example, the database 110 in which data referred to or managed by the additional data creation processing unit 101 is stored. Processing units provided through execution of the target computer program by the CPU 11 are an exemplary reception unit and an exemplary processing unit. The auxiliary storage unit 13 or the database 110 included in the auxiliary storage unit 13 is an exemplary storage unit.

(DB Server)

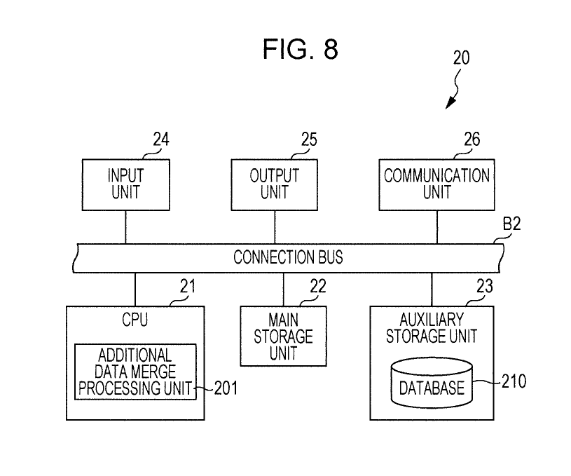

FIG. 8 exemplarily illustrates an exemplary hardware configuration of the database server 20. The database server 20 exemplarily illustrated in FIG. 8 includes a CPU 21, a main storage unit 22, an auxiliary storage unit 23, an input unit 24, an output unit 25, and a communication unit 26, which are coupled with each other through a connection bus B2. The main storage unit 22 and the auxiliary storage unit 23 are recording media readable by the database server 20. The auxiliary storage unit 23 is a recording device storing the database 210.

In the database server 20, the CPU 21 loads, in an executable form in a work area of the main storage unit 22, a computer program stored in the auxiliary storage unit 23, and controls a peripheral instrument through execution of the computer program. In this manner, the database server 20 may execute processing in accordance with a predetermined purpose.

The CPU 21, the main storage unit 22, the auxiliary storage unit 23, the input unit 24, the output unit 25, and the communication unit 26 have functions similar to those of the CPU 11, the main storage unit 12, the auxiliary storage unit 13, the input unit 14, the output unit 15, and the communication unit 16, respectively, included in the preprocessing server 10. Thus, description of these components will be omitted in the following.

In the database server 20, the CPU 21 provides an additional data merge processing unit 201 together with execution of a target computer program, by reading, onto the main storage unit 22, and executing an OS, various computer programs, and various kinds of data stored in the auxiliary storage unit 23. The database server 20 includes, in the auxiliary storage unit 23, for example, the database 210 in which data referred to or managed by the additional data merge processing unit 201 is stored.

In the explanatory diagram in FIG. 6, the preprocessing server 10 creates an index having the trie structure for the input data D4 by using partial information of the input data D4 for which the index is created. The creation of an index for the input data D4 is mainly performed by the additional data creation processing unit 101 of the preprocessing server 10. An index having the trie structure is a file for implementing, in an array form or a list form, a node and an edge (pointer) linking nodes.

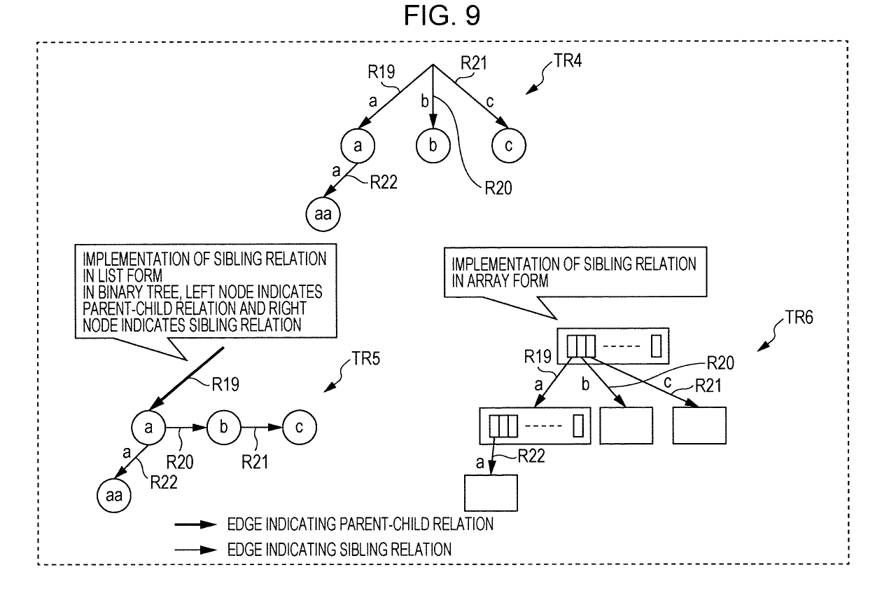

FIG. 9 is an explanatory diagram of the implementation of an index having the trie structure. In FIG. 9, TR4 represents an exemplary trie structure. Nodes as data elements of the index are represented by characters such as “a”, “b”, and “c”. In TR4, a blank root node is linked to child node “a” through edge R19, with child node “b” by edge R20, and with child node “c” by edge R21. In TR4, child node “a” is additionally linked to grandchild node “aa” through edge R22.

In TR5, TR4 is implemented in a list form. Child node “a” on a left side in tree structure TR4 is linked with edge R19 representing the parent-child relation. Child node “a” is also linked to child node “b” through edge R20 representing the sibling relation. Child node “b” is linked to child node “c” through edge R21 representing the sibling relation. Child node “a” is also linked to grandchild node “aa” through edge R22 representing the parent-child relation. In the list form, one of nodes in the sibling relation is linked to a parent node through an edge. In the list form, nodes in the sibling relation are represented by an edge between child nodes. In TR5 in FIG. 9, the order of nodes in the sibling relation is represented by an edge.

As illustrated in TR6, in which TR4 is implemented in an array form, pointers (edges) to nodes “a”, “b”, and “c” in the sibling relation are arranged in the data element of a root node. Edge R19, edge R20, and edge R21 in the root node as edges representing the sibling relation are arranged in this order from the left side in tree structure TR4. In TR6, the order of each node in the sibling relation is indicated as its position in an array. Similarly, edge R22 linking grandchild node “a” is arranged in the data element of child node “a”.

In an index having the trie structure, a node as a data element is implemented as a fixed-length region inside the file. When the file has a size of n bytes (n is a natural number of 1 to n), a node region occupies a region of n bytes from the k-th byte. The node region includes a terminal end flag indicating whether the node of interest is a terminal end (having no child node), the data element value of any child node, and an edge pointing to the child node (offset value to the storage position of the child node). In the explanatory example in FIG. 9, the data element values of child nodes are characters such as “a”, “b”, and “c”.

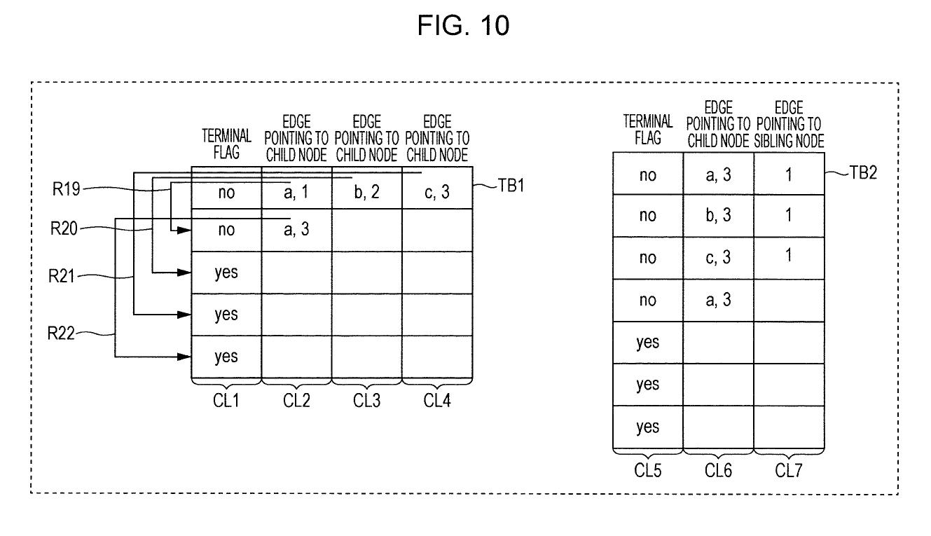

FIG. 10 illustrates an exemplary implementation of the trie structure in the array and list forms. TB1 is an exemplary array-form implementation of TR4 illustrated in FIG. 9, and TB2 is an exemplary list-form implementation of TR4. The exemplary implementations of TB1 and TB2 are exemplary implementations when the data element value of a child node is combined with any edge pointing to the child node.

As indicated in TB1, a record includes a column CL1 storing the terminal end flag indicating whether the node of interest is a terminal end. The record also includes columns CL2 to CL4 storing information as combination of the data element value of a child node and any edge pointing to the child node. In the record of TB1, the column CL1 storing the terminal end flag is arranged at, for example, the first part of the record. A column storing the information as combination of the data element value of a child node and any edge pointing to the child node is continuously arranged following the column CL1. Hereinafter, information as combination of the data element value of a node and any edge pointing to the node is also referred to as node information. In the record of TB1, the number of columns in which the node information is stored is the number of child nodes in the sibling relation.

In the example illustrated in FIG. 10, the column CL1 stores, as the terminal end flag, information in two values of “yes” indicating that the node of interest is a terminal end and “no” indicating that the node of interest is not a terminal end. The columns CL2 to CL4 store, as the node information, for example, array data expressed in the form of (the data element value of a child node, an edge pointing to the child node).

In TB1, a record on the first row represents a root node. Since TR4 illustrated in FIG. 9 includes three child nodes, the column CL1 of the record for the root node stores the terminal end flag “no”. The column CL2 of the record stores “a, 1” as the node information on child node “a”. Similarly, the column CL3 of the record stores “b, 2” as the node information on child node “b”, and the column CL3 thereof stores “c, 3” as the node information on child node “c”.

In TR4, child nodes “b” and “c” have no grandchild node as illustrated in FIG. 9. In the array form, to express the child nodes (terminal ends having data element values), an offset value to a record storing the terminal end flag “yes” in the column CL1 is stored in combination with the data element values of the child nodes. In the record storing the terminal end flag “yes” in the column CL1, any other column is blank.

In TB1, a record on the second row represents grandchild node “aa” of child node “a”, and stores the terminal end flag “no” in the column CL1. The column CL2 of the record stores “a” as the data element value of the grandchild node in combination with an offset value (edge) to a record storing the terminal end flag “yes” in the column CL1. In TB1, records storing the terminal end flag “yes” in the column CL1 are continuously arranged on the third row or later. In TR4, the number of nodes as terminal ends is three. Thus, in TB1 in the array form, the number of records arranged on the third row or later and storing the terminal end flag “yes” in the column CL1 is “3”.

Implementation of the trie structure in the list form is exemplarily illustrated by TB2. As exemplarily illustrated in TB2, in the list form, a node in the trie structure is expressed as a record. Each record includes a column CL5 storing the terminal end flag indicating whether the node of interest is a terminal end. The record in the list form includes a column CL6 storing the node information of a child node, and a column CL7 storing an edge (offset value) between nodes in the sibling relation.

In the record in the list form, the column CL5 is arranged at the first part of the record and stores the terminal end flag same as that in the column CL1. The node information of a child node stored in the column CL6 is same as the node information described with reference to the column CL2 of TB1. The column CL7 stores, as an edge, an offset value between nodes in the sibling relation. Similarly to the array form, to express a node having a data element value and serving as a terminal end, the column CL6 stores, in combination with the data element value, an offset value to a record storing the terminal end flag “yes” in the column CL5. In the record storing the terminal end flag “yes” in the column CL5, any other column is blank.

In TB2, records on the first to third rows represents nodes “a”, “b”, and “c”, respectively, having the sibling relation in TR4, and a record on the fourth row represents a grandchild node. In TB2 in the list form, three records storing the terminal end flag “yes” in the column CL1 are arranged on the fifth row or later.

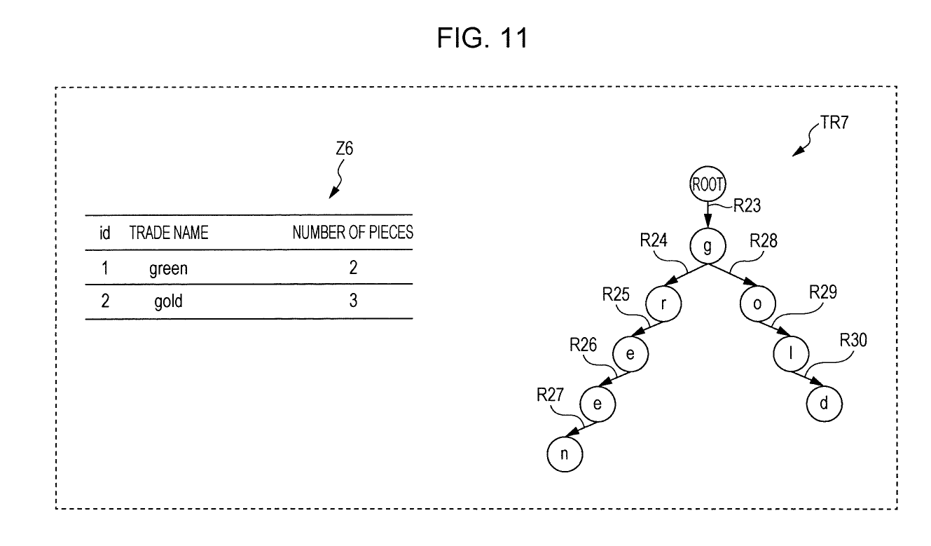

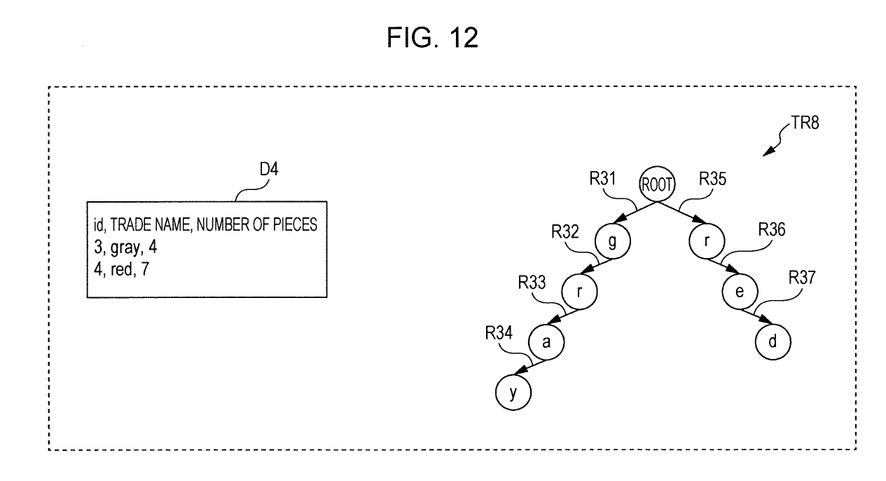

The following describes additional data creation processing performed by the preprocessing server 10 with reference to FIGS. 11 to 15. FIG. 11 exemplarily illustrates an explanatory diagram of an existing index. In FIG. 11, Z6 represents, for example, data accumulated in the database 210 included in the database server 20. The data accumulated in the database 210 is expressed in a table form and stored, for each trade name, as a record including columns of, for example, “id”, “trade name”, and “number of pieces”. For example, when the input data D4 is received, the database 210 stores products with trade names “green” and “gold”.

TR7 illustrates the tree structure of an index for a trade name in Z6. As illustrated in TR7, characters of trade names “green” and “gold” in Z6 are expressed in a tree structure linked through edges R19 to R26. In TR7, for example, an index of trade name “green” is expressed in the order of root node->edge R23->node “g”->edge R24->node “r”->edge R25->node “e”->edge R26->node “e”->edge R27->node “n”. An index of trade name “gold” is expressed in the order of root node->edge R23->node “g”->edge R28->node “o”->edge R29->node “I”->edge R30->node “d”. The preprocessing server 10 stores the data illustrated in Z6 in the database 110, and stores as an existing index, the index having the tree structure illustrated in TR7.

FIG. 12 illustrates an explanatory diagram of an index for the input data D4. The input data D4 is, for example, text data written in CSV. The input data D4 includes data of products having trade names “gray” and “red”. TR8 illustrates the tree structure of an index for a trade name in the input data D4. In TR8, for example, an index of trade name “gray” is expressed in the order of root node->edge R31->node “g”->edge R32->node “r”->edge R33->node “a”->edge R34->node “y”. An index of trade name “red” is expressed in the order of root node->edge R35->node “r”->edge R36->node “e”->edge R37->node “d”.

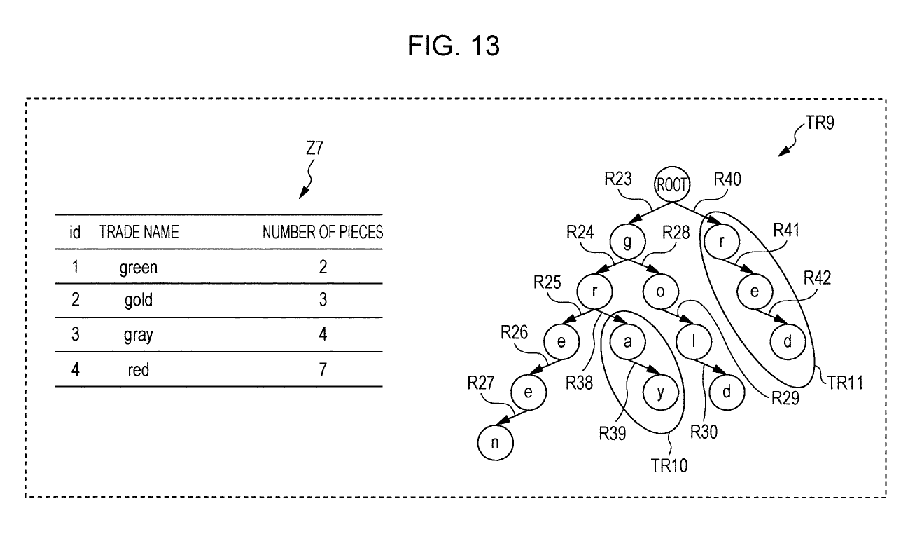

FIG. 13 illustrates an explanatory diagram of an updated index. Z7 illustrates the database 210 in which the input data D4 is stored. As illustrated in Z7, the database 210 includes an additional record associated with a trade name in the input data D4. TR9 illustrates the tree structure of an index for a trade name in Z7.

As illustrated in TR9, in the updated index, nodes “a” and “y” of trade name “gray” are linked to node “r” of trade name “green” through edge R38, forming new subtree TR10. Similarly, trade name “red” is linked to a root node through edge R40, forming new subtree TR11.

The preprocessing server 10 according to the embodiment creates an additional index including subtrees TR10 and TR11 illustrated in TR9 as blocks of new nodes not overlapping the existing index TR7. Since the created new nodes are continuously arranged in the subtrees TR10 and TR11, edges for the created new nodes edges may also be used for TR10 and TR11. In the updated index TR9, rewriting of, for example, edge R34 to edge R39 does not occur. In TR10, rewriting of edge R36 to edge R41 and edge R37 to edge R42 does not occur.

In the database server 20, which creates an updated index, scanning processing on an existing index and an additional index may be terminated when a new node is found in the additional index. This leads to reduction of a load on the database server 20 due to the scanning processing. The following describes the file of an additional index created through the additional data creation processing performed by the preprocessing server 10 according to the embodiment.

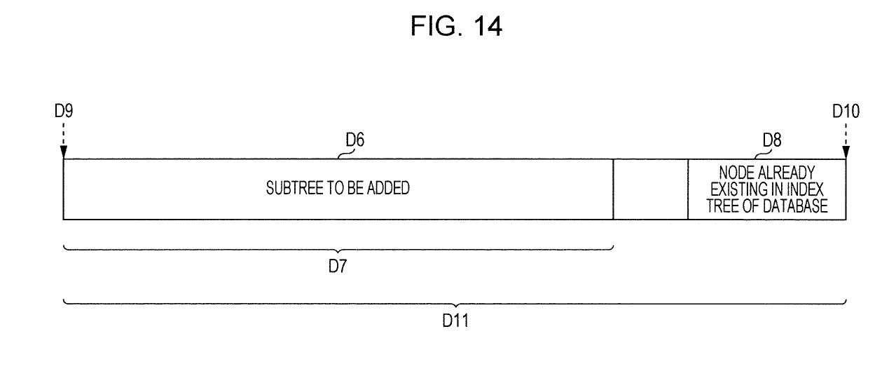

FIG. 14 exemplarily illustrates an explanatory diagram of the file of an additional index. In FIG. 14, D6 represents the file of an additional index created by the preprocessing server 10. The size D11 of the file D6 is a predetermined size. D9 indicates the front end of the file D6, and D10 represents the back end of the file D6. The root node of the additional index is arranged in a node region positioned at the back end of the file D6.

In the additional data creation processing, an existing node in index-creation target data, which is also included in existing index, is arranged in a node region starting from the back end of the file D6. On the other hand, a new node in index-creation target data, which is not included in the existing index, is arranged in a node region starting from the front end of the file D6. Such existing and new nodes are arranged, for example, in an order in which they are found in the index-creation target data.

In the additional data creation processing, the file D6 of an additional index created for the input data D4 is transmitted to the database server 20 as the additional data D5. The additional data D5 includes the region size (for example, the number of bytes from the front end D9) D7 of a block in which a new node is arranged. The additional data D5 also includes the size D11 of the file D6. The following describes the additional data creation processing.

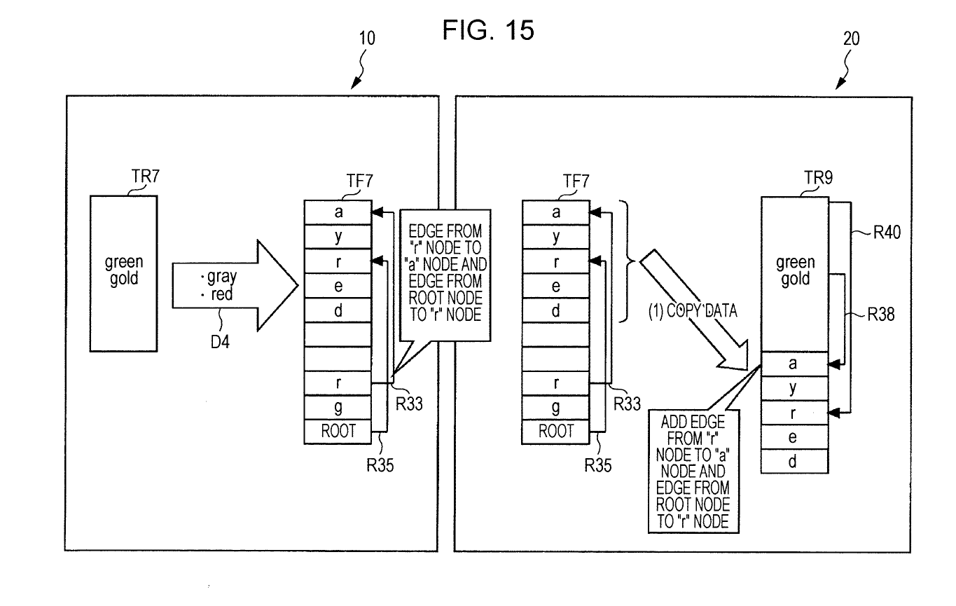

FIG. 15 exemplarily illustrates an explanatory diagram of the additional data creation processing. In FIG. 15, TR7 illustrates the existing index described with reference to FIG. 11. In TR7, each character of strings “green” and “gold” is arranged as an existing node. The input data D4 input to the preprocessing server 10 includes strings “gray” and “red” for each of which an index is to be generated.

In the additional data creation processing, the preprocessing server 10 creates an additional index TF7 by using any existing node in an existing index, and each string in the input data D4, for which an index is to be generated.

The preprocessing server 10 acquires, for example, string “gray” as target data of the additional data creation processing from the input data D4. The preprocessing server 10 compares the first character of the string of the target data and a child node of the root node of the existing index. If the comparison finds that the first character exists as a child node of the root node of the existing index, the preprocessing server 10 arranges the first character in a node region at the back end of the additional index TF7. Node “g” is a child node of the root node of the existing index, and the first character of the target data is “g”. Thus, the preprocessing server 10 arranges the first character “g” of the target data in the node region at the back end of the additional index TF7, and adds an edge between the first character “g” and the root node.

The preprocessing server 10 performs the above-described processing on the second character “r” of the string of the target data and a child node “r”, the parent node of which is node “g” of the existing index. The character “r” matches child node “r”, the parent node of which is node “g”. Thus, the character “r” is arranged in the next node region on the front-end side of the node region of the additional index TF7 in which the first character “g” is arranged, and an edge is added between the character “r” and the first character “g”.

Subsequently, the preprocessing server 10 compares the third character “a” of the string of the target data and a child node “e”, the parent node of which is node “r” of the existing index. The comparison finds that the character “a” does not match child node “e”, the parent node of which is node “r”. The preprocessing server 10 arranges the character “a” not matching node “r” of the existing index in a node region at the front end of the additional index TF7. The preprocessing server 10 adds edge R33 between the character “r” and the character “a”.

The preprocessing server 10 finds that the existing index includes no node matching the character “y” following the third character “a” of the string of the target data. Thus, when having detected that the character “a” matches no node of the existing index, the preprocessing server 10 arranges a string following the character “a” of the target data in a node region of the additional index TF7. In the additional index TF7, the character “y” is arranged in the next node region on the back-end side of the node region in which the character “a” is arranged, and an edge is added between the character “y” and the character “a”.

The preprocessing server 10 terminates the processing, the target data of which is string “gray”. Subsequently, the preprocessing server 10 acquires, as target data, string “red” existing in the input data D4, and continues the additional data creation processing. The preprocessing server 10 performs the additional data creation processing on all strings existing in the input data D4.

In the additional data creation processing on string “red”, the preprocessing server 10 compares, for example, the first character “r” and child node “g” of the root node of the existing index. The comparison finds that the first character “r” does not match child node “g”. The preprocessing server 10 arranges the first character “r” in the next node region on the back-end side of the node region of the additional index TF7 in which the character “y” is arranged, and adds edge R35 between the first character “r” and the root node.

The preprocessing server 10 finds that the existing index includes no node matching string “ed” following the character “r” of string “red” of the target data. Thus, when having detected that the character “r” matches no node of the existing index, the preprocessing server 10 arranges string “ed” following the character “r” of the target data in a node region of the additional index TF7. In the additional index TF7, the character “e” is arranged in the next node region on the back-end side of the node region in which the character “r” is arranged, and an edge is added between the character “e” and the character “a”. The character “d” is arranged in the next node region on the back-end side of the node region in which the character “e” is arranged, and an edge is added between the character “d” and the character “e”. The preprocessing server 10 terminates the processing, the target data of which is string “red”.

The additional data creation processing on the input data D4 is completed, and the additional index TF7 is created. In the additional index TF7, the subtrees illustrated in TR10 and TR11 in FIG. 13 are continuously arranged in node regions on the front-end side in the file. In the additional index TF7, existing nodes included in the existing index is arranged in a node region on the back-end side in the file.

The preprocessing server 10 transmits the created additional index TF7 for the input data D4 to the database server 20 as the additional data D5. The preprocessing server 10 includes, in the additional data D5 transmitted to the database server 20, the region size D7 of the subtrees TR10 and TR11 arranged in the additional index TF7 and the size D11 of the entire additional index TF7.

The following describes additional data merge processing performed by the database server 20 with reference to FIG. 15. The additional data merge processing is mainly performed by the additional data merge processing unit 201 of the database server 20. The additional data merge processing copies data of the subtrees TR10 and TR11 of the additional index TF7 transmitted from the preprocessing server 10. The region of the subtrees TR10 and TR11 arranged in the additional index TF7 is specified based on the region size D7 included in the additional data D5. The copied data of the subtrees TR10 and TR11 is merged with the existing index TR7 as illustrated in TR9 in FIG. 15.

The database server 20 scans the existing index merged with the data of the subtrees TR10 and TR11, and the additional index TF7, and rewrites any edge between an existing node and the subtrees TR10 and TR11. For example, edge R33 in TF7 is rewritten to edge R38, and edge R35 in TF7 is rewritten to edge R40. The database server 20 terminates the scanning when the rewriting of any edge between an existing node and the subtrees TR10 and TR11 is performed. In a subtree in which new nodes are continuously arranged, a relative positional relation among the new nodes does not change through the copying, and thus no change occurs in any edge linking new nodes. This allows any edge in the additional index TF7 to be used in the subtrees TR10 and TR11. The additional data merge processing obtains, in the database server 20, the updated index TR9 in which the index for the input data D4 is merged with the existing index TR7.

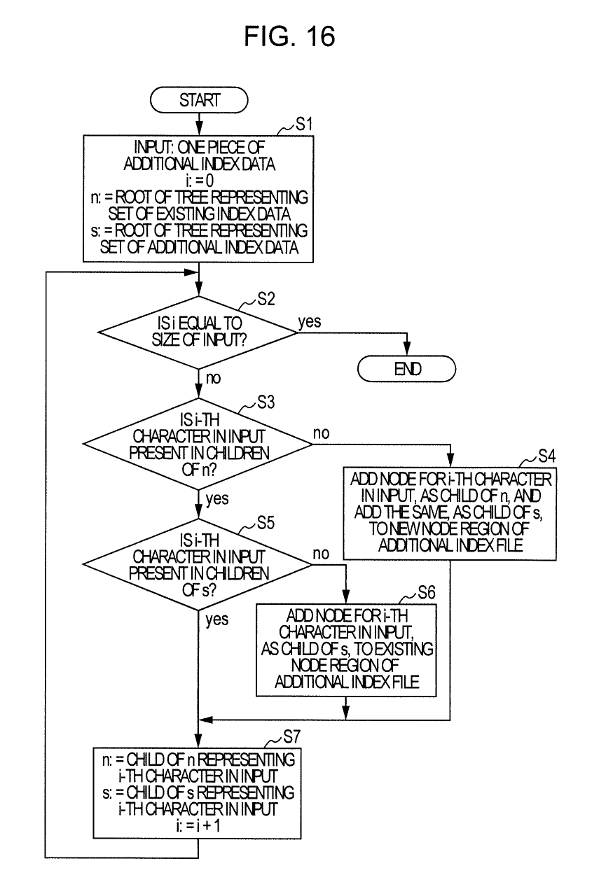

FIG. 16 is a flowchart illustrating the additional data creation processing performed by the preprocessing server 10.

Upon reception of the input data D4, the preprocessing server 10 starts the processing according to the flowchart illustrated in FIG. 16. The preprocessing server 10 stores therein the received input data D4 in a predetermined region of the main storage unit 12. The preprocessing server 10 acquires an existing index file in the database 110. The acquired file is stored in the database 110 in the auxiliary storage unit 13. The processing illustrated in FIG. 16 is performed on each string included in the input data D4, for which an index is to be created.

In the processing at S1, the preprocessing server 10 substitutes “0” into a processing variable i for the acquired string. The preprocessing server 10 also substitutes, into a processing variable n, the address of the root node of an existing index loaded onto a work file. The preprocessing server 10 also substitutes, into a processing variable s, the address of the root node of an additional index.

The preprocessing server 10 determines whether the processing variable i is equal to the size of a string (the number of characters) in the input data D4, for which additional data is to be created (S2). When the processing variable i is equal to the size of the string (yes at S2), the preprocessing server 10 terminates the processing exemplarily illustrated in FIG. 16. When the processing variable i is not equal to the size of the string (no at S2), the preprocessing server 10 advances to the processing at S3.

In the processing at S3, the preprocessing server 10 determines whether the i-th character of the string in the input data D4, for which additional data to be created, is present in children of a node in the existing index indicated by the processing variable n. When the i-th character is not found in the children of the node (no at S3), the preprocessing server 10 advances to the processing at S4. When the i-th character is present in the children of the node (yes at S3), the preprocessing server 10 advances to the processing at S5.

In the processing at S4, the i-th character is a newly added node in the input data D4. Thus, the preprocessing server 10 adds, as a child, the i-th character to the node of the existing index indicated by the processing variable n. The preprocessing server 10 adds, as a child of the node indicated by the processing variable s, the i-th character to a new node region of an additional index file. At the addition of a new node, an edge is added as an offset of a relative position to the parent node.

For example, it is assumed that, in the existing index, each character of “green” is arranged as an existing node. When string “gray” is to be processed, characters “a” and “y” are added to the existing index as new nodes through the processing at S3 (no) to S4. Through the processing at S3 (no) to S4, nodes for characters “a” and “y” are continuously arranged in the node regions of new nodes in the additional index as described with reference to FIG. 15. Edge R33 to an existing node “r” arranged in the file is added to character “a”, and edge R34 (not illustrated) to character “a” is added to character “y”. After the processing at S4, the preprocessing server 10 advances to the processing at S7.

In the processing at S5, the preprocessing server 10 determines whether the i-th character of a string for which additional data is to be created is present in children of a node in the additional index indicated by the processing variable s. When the i-th character is not found in the children of the node (no at S5), the preprocessing server 10 advances to the processing at S6. When the i-th character is present in the children of the node (yes at S5), the preprocessing server 10 advances to the processing at S7.

In the processing at S6, the preprocessing server 10 adds a node for the i-th character of the string into an existing node region of the additional index file as a child of the node in the additional index indicated by the processing variable s. At the addition of a new node, an edge is added as an offset of a relative position to the parent node.

For example, it is assumed that, in the existing index, each character of “green” is arranged as an existing node. String “gray” is input as an additional index. Through the processing at S5 (no) to S6, nodes for characters “g” and “r” of string “gray” are continuously arranged in a node region of the additional index file, in which an existing node is arranged, as described with reference to FIG. 15. An edge to the root node is added to character “g”, and an edge to character “g” is added to character “r”. After the processing at S6, the preprocessing server 10 advances to the processing at S7.

At S7, the preprocessing server 10 substitutes, into the processing variable n, a child node of the processing variable n corresponding to the i-th character of a string for which additional data is to be created. The preprocessing server 10 also substitutes, into the processing variable s, a child node of the processing variable s corresponding to the i-th character of the string for which additional data is to be created. Then, the preprocessing server 10 increments the processing variable i by substituting i+1 to the processing variable i.

After the processing at S7, the preprocessing server 10 advances to the processing at S2.

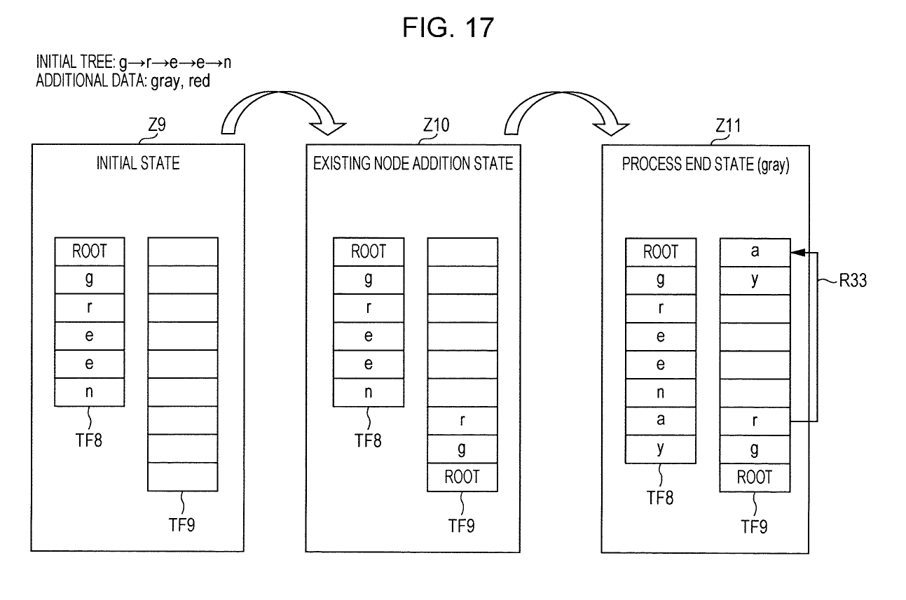

FIG. 17 is an explanatory diagram for description of transition of the state of nodes arranged in a file at the additional data creation processing. In FIG. 17, TF8 represents a work file, and TF9 represents an additional index file. In an existing index, each character of string “green” is arranged as an existing node. The input data D4 includes strings “gray” and “red” for which an additional index is to be created.

In FIG. 17, Z9 illustrates a state at start of the additional data creation processing. Specifically, in the work file TF8, each character of string “green” is arranged as an existing node. In the additional index file TF9, no node is arranged.

Z10 illustrates a state in which nodes for characters which correspond to nodes included in the existing index are arranged in the additional index after the additional data creation processing is performed on string “gray”. No node is added to the work file TF8, but existing nodes “g” and “r” are added at the back end (root node side) of the additional index file TF9.

Z11 illustrates a state in which the processing on string “gray” has ended after the additional data creation processing is performed in the state illustrated in Z10. New nodes “a” and “y” are added at the front end of the additional index file TF9. In the work file TF8, new nodes “a” and “y” are added at positions following a position at which node “n” is arranged. In the additional index file TF9, edge R33 is added between existing node “r” and new node “a”.

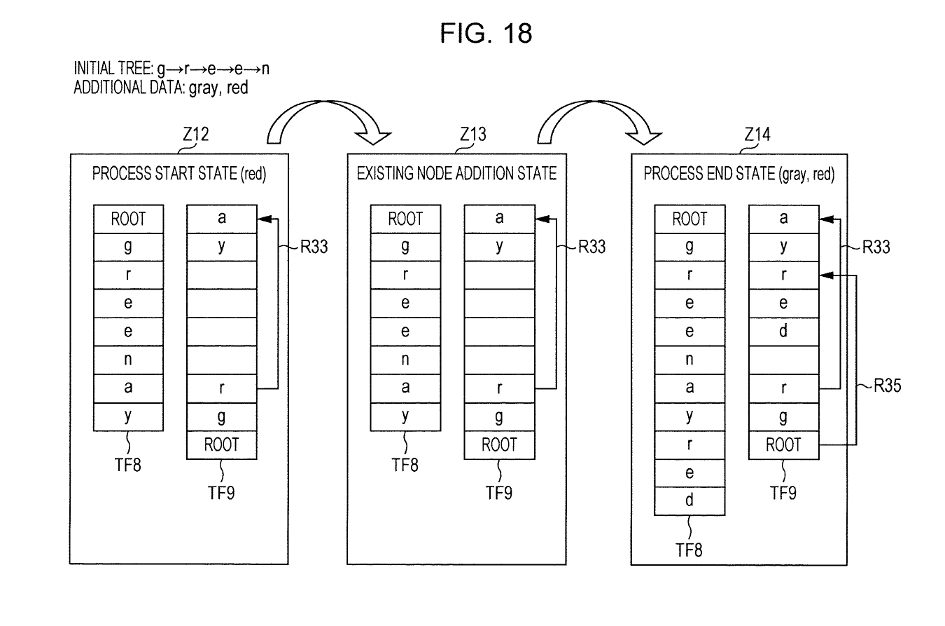

FIG. 18 is an explanatory diagram for description of transition of the state of nodes arranged in a file when the additional data creation processing is continued for another string. In FIG. 18, Z12 illustrates a state at start of the additional data creation processing on string “red” after the processing on string “gray” has ended. The state illustrated in Z12 is same as that in Z11.

Z13 illustrates a state in which nodes for characters which correspond to nodes included in the existing index is arranged in the additional index after the additional data creation processing is performed on string “red”. Since string “red” includes none of the character included in the nodes in the existing index, the state illustrated in Z13 is same as that in Z12.

Z14 illustrates a state in which the processing on string “red” has ended after the additional data creation processing is performed in the state illustrated in Z13. New nodes “r”, “e”, and “d” are added at positions following the position of node “y” arranged at the front end of the additional index file TF9. In the work file TF8, new nodes “r”, “e”, and “d” are added at positions following a position at which node “y” is arranged. In the additional index file TF9, edge R35 is added between the root node and new node “r”.

In the above example, the preprocessing server 10 arranges a new node on the front-end side (side opposite to a root node) in the additional index file TF9, and arranges an existing node on the back-end side (side on which the root node is arranged) in the additional index file TF9. Furthermore, for example, in the additional index file TF9, the side on which the root node is arranged may be on the front-end side, and the side opposite to the root node may be on the back-end side. All that is required is to divide the additional index file TF9 into a region in which a new node is arranged and a region in which an existing node such as a root node is arranged. This division facilitates specification of a region in which a new node is copied at the database server 20.

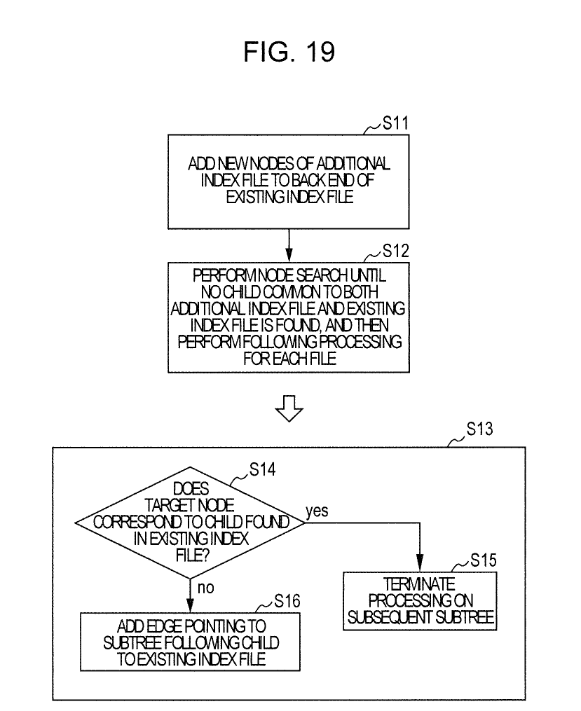

The following describes the additional data merge processing according to the embodiment with reference to a flowchart illustrated in FIG. 19.

The database server 20 performs processing illustrated in FIG. 19 by causing the CPU 21 to load, into the main storage unit 22, various computer programs and various kinds of data stored in the auxiliary storage unit 23, and by executing the same.

In the flowchart illustrated in FIG. 19, the database server 20 starts processing with reception of the additional data D5. The database server 20 receives the additional data D5, and temporarily stores the received additional data D5 in a predetermined region of the main storage unit 22. The database server 20 acquires an existing index file by referring to the database 210. The acquired file is stored in a work file provided in a predetermined region of the main storage unit 22.

In the processing at S11, the database server 20 specifies a region in which new nodes are continuously arranged in the file of an additional index in the additional data D5. This region is specified based on the region size D7 included in the additional data D5. The database server 20 copies the region and adds the copied region to the existing index file. The region is added at a position following the position of an existing node arranged at the back end of the existing index.

In the additional index file TF9 illustrated in Z14 in FIG. 18, new nodes “a”, “y”, “r”, “e”, and “d” are continuously arranged on the front-end side in the file. The database server 20 adds the continuously arranged new nodes to the existing index file. For example, the existing index file is the work file TF8 illustrated in Z9 in FIG. 17. The database server 20 copies the continuously arranged new nodes, and adds the copied new nodes at positions following the position of existing node “n” arranged in the work file TF8.

In the processing at S12, the database server 20 performs node search until no child common to both the file to which the new nodes are added through the processing at S11 and the additional index file is found. Then, when no child common to the both files is found, the database server 20 performs the processing at S13.

When a target node of the processing at S12 corresponds to a child node found in the existing index file (yes at S14), the database server 20 advances to S15. In the processing at S15, since any node following the child node determined at S12 forms an existing subtree, the database server 20 terminates processing on the subsequent subtree. When the target node of the processing at S12 corresponds to a child node found in the additional index file (no at S14), the database server 20 advances to S16. In the processing at S16, the database server 20 adds an edge pointing to a subtree following the child node determined at S12 to the existing index file.

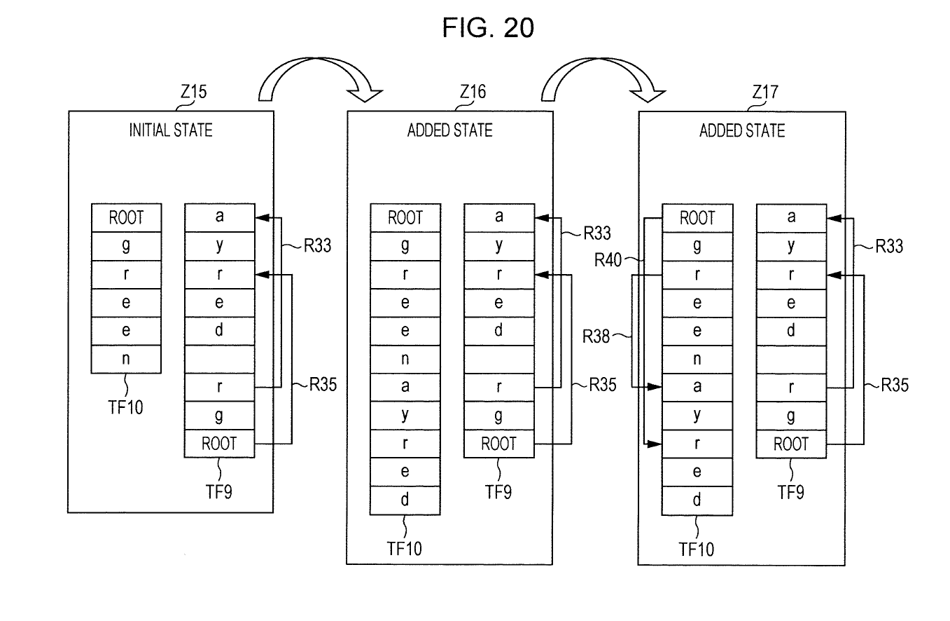

FIG. 20 exemplarily illustrates an explanatory diagram of addition of an edge between an existing node and a new node. In FIG. 20, TF10 illustrated in Z15 represents a work file of the database server 20, including an existing index file. TF9 illustrated in Z15 represents an additional index.

Z16 illustrates a state in which new nodes are copied and added to the work file TF10 through the processing at S11. In TF10, existing nodes “g”, “r”, “e”, “e”, and “n” are arranged in this order, and the added new nodes “a”, “y”, “r”, “e”, and “d” are arranged in this order. In the additional index file TF9, existing nodes “g” and “r” are arranged in this order from the root node, and new nodes “a”, “y”, “r”, “e”, and “d” are arranged in this order from the front end of the file.

It is assumed that scanning is performed by the depth-first search for TF9 and TF10. In the depth-first search, nodes “g” and “r” are searched as common child nodes in TF10 through the processing at S12. In TF10, “e” is a child node of “r”, whereas “a” is a child node of “r” in TF9. Thus, the processing at S12 exemplarily illustrated in FIG. 18 advances to the processing at S13.

In the processing at S13, the processing at S14 (yea) to S15 is performed on an existing subtree of TF10, and processing on an existing subtree (“e”, “e”, and “n”) following node “e” is terminated. In TF9, child node “a” of “r” and child node “y” of “a” form a subtree new to the existing index. Thus, the processing at S14 (no) to S16 is performed for TF10 to add edge R38 pointing from existing node “r” to the merged new node “a” (Z17).

After the processing at S16, the database server 20 recursively performs the processing at S12 to S13 for any other edge relation linked with the root node. In the subtree of existing nodes of TF10, there exists no node other than node “g” linked to the root node. The root node of TF9 has an edge pointing to new node “r”. Thus, the processing at S12 exemplarily illustrated in FIG. 18 advances to the processing at S13. In the processing at S13, the processing at S14 (yes) to S16 is performed to add edge R40 pointing from the root node of TF10 to merged new node “r” (Z17).

As illustrated in Z17, update processing is completed for TF10 in which any edge to a merged new subtree is rewritten according to each edge between an existing node and a new node in TF9. The updated TF10 is an index for the database to which the input data D4 is added.

As described above, the preprocessing server 10 according to the embodiment may extract, based on existing node information of index data, new node information from input data of an index-creation target. The preprocessing server 10 may generate added tree data by continuously rearranging contents of the extracted new node information. The preprocessing server 10 may write a relative relation between rearranged nodes to the added tree data, based on a relative relation between nodes in the input data of the index-creation target, and may transmit the added tree data to a DB server configured to manage index data.

As a result, the DB server according to the embodiment additionally writes the continuous new node information of the added tree data to tree data of an index managed by the DB server, and rewrites a relative relation between an existing node and a new node, thereby restructuring an index after the input data addition. This leads to omission of processing performed by the DB server to restructure a relative relation between new nodes.

[Computer-Readable Recording Medium]

A computer program configured to cause a computer or any other machine or device (hereinafter collectively referred to as a computer) to achieve any of the above-described functions may be recorded on a computer-readable recording medium. The function may be provided by causing a computer to read and execute the computer program on the recording medium.

Such a computer-readable recording medium may store, in a computer-readable manner, information such as data and computer programs by an electrical, magnetic, optical, mechanical, or chemical effect. Among such recording media, examples of those removable from a computer include a flexible disk, a magneto optical disc, a CD-ROM, a CD-R/W, a DVD, a Blu-ray Disc, a DAT, an 8 mm tape, and a memory card such as a flash memory. Examples a recording medium fixed to a computer include a hard disk and a ROM.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An apparatus to execute preprocessing for an information processing apparatus that maintains a database according to index data having a tree structure, the tree structure including plural pieces of node data and plural pieces of edge data linking the plural pieces of node data, the apparatus comprising:
a memory configured to store existing index data of the database; and
a processor coupled to the memory and configured to:
receive input data to be added to the database,
compare the existing index data with input index data included in the input data,
extract, from the input index data, new node data indicating a difference between the existing index data and the input index data,
create additional index data including new tree data in which pieces of the new node data are continuously arranged, and
transmit the additional index data to the information processing apparatus.

2. The apparatus of claim 1, wherein,
the processor generates, from the input data, partial tree data indicating node data of the input data that is already included in the existing index data, and adds the partial tree data to the additional index data.

3. A method performed by an apparatus configured to execute preprocessing for an information processing apparatus that maintains a database according to index data having a tree structure, the tree structure including plural pieces of node data and plural pieces of edge data linking the plural pieces of node data, the method comprising:
providing the apparatus with existing index data of the database
receiving input data to be added to the database;
comparing the existing index data with input index data included in the input data;
extracting, from the input index data, new node data indicating a difference between the existing index data and the input index data,
creating additional index data including new tree data in which pieces of the new node data are continuously arranged; and
transmitting the additional index data to the information processing apparatus.

4. A non-transitory, computer-readable recording medium having stored therein a program for causing a computer to execute a process, the computer being included in an apparatus configured to execute preprocessing for an information processing apparatus that maintains a database according to index data having a tree structure, the tree structure including plural pieces of node data and plural pieces of edge data linking the plural pieces of node data, the process comprising:
providing the apparatus with existing index data of the database;
receiving input data to be added to the database;
comparing the existing index data with input index data included in the input data;
extracting, from the input index data, new node data indicating a difference between the existing index data and the input index data,
creating additional index data including new tree data in which pieces of the new node data are continuously arranged; and
transmitting the additional index data to the information processing apparatus.
